(19) United States
(12) Patent Application Publication
(10) Pub. No.: US 2009/0228260 A1
(43) Pub. Date: Sep. 10, 2009

(54) Apparatus and method for generating power supply noise model

(75) Inventor: Fumikazu Ga, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/385,209

(22) Filed: Apr. 1, 2009

(30) Foreign Application Priority Data
Feb. 4, 2008 (JP) 2008-096453

(51) Int. Cl. G06F 17/50

(52) U.S. Cl. 703/13

(57) ABSTRACT

In a power supply noise model generating method, a layout pattern of a design target circuit layout is divided into divisional regions, and a distribution coefficient is calculated to each of the divisional regions based on a noise parameter in each divisional region. Noise generated from a whole of the design target circuit is distributed to the divisional regions based on the distribution coefficients, and a power supply noise model of the design target circuit is generated by connecting a noise source corresponding to the distributed noise to a corresponding one of the divisional regions.

### INCORPORATION BY REFERENCE

This patent application claims priority on convention based on Japanese Patent Application No. 2008-096453. The disclosure thereof is incorporated herein by reference.

### BACKGROUND OF THE INVENTION

1. Field of the Invention

The present invention relates to a power supply noise model generating method, and a power supply noise model generating apparatus.

2. Description of Related Art

An electromagnetic radiation noise emitted from an LSI (Large Scale Integrated circuit) is not only a cause of EMI (Electro-Magnetic Interference) to other apparatuses but also a cause of obstruction of its own circuit operation. Accordingly, it is desired to suppress the electromagnetic radiation noise as far as possible. In particular, the number of transistors, the number of input and output pins, and an operation frequency notably increase in accompaniment with speeding-up and high integration of the LSI, so that an amount of noise from the LSI inevitably increases. In addition, even when receiving the noise of a same level, a semiconductor element malfunctions more easily than ever with the refinement of process. Thus, the reduction of EMI is one of the most important subjects in a LSI design.

To measure the EMI, many designers use an EMI simulator. The EMI simulator calculates the electromagnetic radiation noise emitted from the LSI in the consideration of a signal level, an operation speed of the LSI, and interconnection paths on a printed circuit board. The calculation of the electromagnetic radiation noise requires a transmission line model of a board interconnection and a model of the LSI mounted on the printed circuit board.

One of major sources of the EMI emitted from the printed circuit board is a power supply current including many high-frequency components. Accordingly, it is particularly important to accurately simulate a radiated electromagnetic field generated by a high-frequency power supply current flowing through a power supply system of the LSI. It is necessary to provide an LSI power supply system model as accurate as possible (hereinafter referred to as a power supply noise model) for the accurate simulation.

Japanese Patent Application Publication (JP-P2004-362074A) discloses a method for generating such a power supply noise model. In the method, the power supply noise model is generated by dividing an interconnection model of an LSI into a plurality of regions and calculating an amount of current (a noise amount) for each divisional region. To be more detailed, power supply interconnections of a design target LSI are separated into a plurality of layers for each type of the power supply, and the respective layers are divided into a plurality of lattice-shaped regions. Then, a power supply interconnection model is generated for each region by using resistances and inductances. Next, in consideration of a switching timing of each of logical gates included in the region, the consumption current of the region is calculated. The power supply noise model is generated by incorporating the consumption current of each region and internal capacitances of each region into the power supply interconnection model.

However, in Japanese Patent Application Publication (JP-P2004-362074A), since a noise amount of each region is calculated based on the consumption current of each divisional region, there is a possibility that an absolute value of the noise amount is not coincident with that of an amount of actually emitted noise. In this way, a noise amount obtained through an actual measurement and of a noise amount obtained through highly accurate simulation is different from the noise amount obtained through a simulation using a conventional power supply noise model. In other words, the conventional power supply noise model cannot accurately estimate an absolute value of the amount of noise emitted in each region.

### SUMMARY

In an aspect of the present invention, a power supply noise model generating method is achieved by dividing a layout pattern of a design target circuit layout into divisional regions; by calculating a distribution coefficient to each of the divisional regions based on a noise parameter in each divisional region; by distributing noise generated from a whole of the design target circuit to the divisional regions based on the distribution coefficients; and by generating a power supply noise model of the design target circuit by connecting a noise source corresponding to the distributed noise to a corresponding one of the divisional regions.

In another aspect of the present invention, a power supply noise model generating apparatus includes: a storage section configured to store a data of a layout pattern of a design target circuit; a dividing section configured to divide the design target circuit into divisional regions by using the layout pattern data; a distribution coefficient calculating section configured to calculate a distribution coefficient to each of the divisional regions based on a noise parameter in each divisional region; and a noise distributing section configured to distribute noise generated from the whole of the design target circuit to the divisional regions based on the distribution coefficients, and generate power supply noise models of the design target circuit by connecting noise sources corresponding to distributed portions of the noise with the divisional regions.

In still another aspect of the present invention, a computer-readable recording medium is provided in which a computer-readable program code is recorded to realize a power supply noise model generating method. The power supply noise model generating method includes dividing a layout pattern of a design target circuit layout into divisional regions; calculating a distribution coefficient to each of the divisional regions based on a noise parameter in each divisional region; distributing noise generated from a whole of the design target circuit to the divisional regions based on the distribution coefficients; and generating a power supply noise model of the design target circuit by connecting a noise source corresponding to the distributed noise to a corresponding one of the divisional regions.

According to the present invention, a power supply noise model generating method, a power supply noise model generation program, and a power supply noise model generating apparatus are provided and a highly accurate power supply noise model for a semiconductor integrated circuit can be generated.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram showing a configuration of a power supply noise model generating apparatus according to the present invention;

FIG. 2 is a block diagram showing a functional configuration of the power supply noise model generating apparatus according to an embodiment of the present invention;

FIG. 3 is a flowchart showing an operation of an operation rate calculation section in the power supply noise model generating apparatus in the embodiment;

FIG. 4 is a flowchart showing a power supply noise model generating process in the embodiment of the present invention;

FIG. 5 is a diagram showing an example of a circuit division model according to the present invention;

FIG. 6 is a diagram showing an example of an operation frequency of a design target LSI circuit according to the present invention; and

FIG. 7 is a diagram showing an example of a power supply noise generating model according to the present invention.

### DESCRIPTION OF THE PREFERRED EMBODIMENTS

Hereinafter, a power supply noise model generating apparatus of the present invention will be described in detail with reference to the attached drawings.

The power supply noise model generating apparatus according to the present invention generates a power supply noise model by dividing a layout pattern region of an LSI into a plurality of divisional regions and adding current sources to each of the divisional regions. In this case, the current source corresponding to current flowing in the divisional region is added to the divisional region.

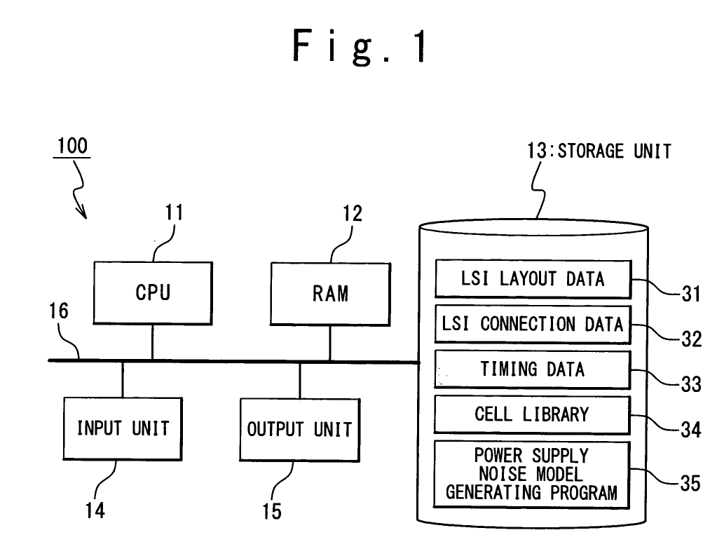

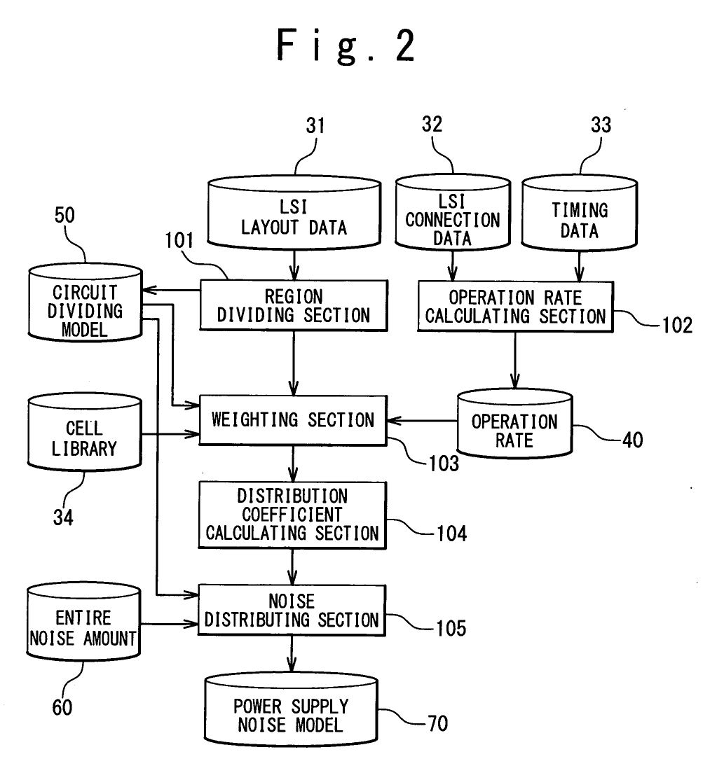

Next, referring to FIGS. 1 and 2, a configuration of a power supply noise model generating apparatus 100 according the present invention will be described.

FIG. 1 is a diagram showing a configuration of the power supply noise model generating apparatus 100. Referring to FIG. 1, the power supply noise model generating apparatus 100 according to the present invention includes a CPU 11, a RAM 12, a storage unit 13, an input unit 14, and an output unit 15 connected to each other via a bus 16. The storage unit 13 is an external memory unit such as a hard disk and a memory unit. The input unit 14 such as a key board and a mouse is operated by a user to input various types of data to the CPU 11 and the storage unit 13. The output unit 15 such as a monitor and a printer outputs a layout result of a semiconductor integrated circuit from the CPU 11 so that a user can recognize the result.

The storage unit 13 stores LSI layout data 31, LSI connection data 32, timing data 33, cell library 34, and a power supply noise model generation program 35 which is loaded from a recording medium (not shown). The LSI layout data 31 includes arrangement data of power supply interconnections, standard cells, and macro cells (the standard cells and the macro cells are hereinafter collectively referred to as cells) in a design target LSI. The LSI connection data 32 shows connection of the cells as a result of logic circuit design. The LSI connection data 32 includes connection data of logic gates and circuit elements (resistances, capacitances, and inductances) in the design target LSI. The timing data 33 defines an operation frequency of an operation clock signal in each cell in the LSI and an operation condition of the LSI. The cell library 34 includes data related to the cells to be provided in the design target LSI. The cell library 34 stores data related to the standard cells including a basic circuit such as a NAND and a flip-flop and to the macro cells including a large-scale circuit such as a RAM, a ROM, and a CPU core. Here, the cell library 34 includes a parameter (a noise parameter) affecting a current flowing in the cell. The noise parameter is exemplified by a gate width of a logic gate and the number of transistors in the cell. In addition, the noise parameter of a cell is related to the cell, and both of them are stored in the storage unit 13.

In response to an instruction from the input unit 14, the CPU 11 executes the power supply noise model generation program 35 in the storage unit 13 to execute a power supply noise model generating process and a power supply noise design process. At this time, various types of data and programs from the storage unit 13 are temporarily stored in the RAM 12, and the CPU 11 executes various types of processes by using the data in the RAM 12.

Referring to FIG. 2, the power supply noise model generation program 35 is executed by the CPU 11 to realize functions of a region dividing section 101, an operation rate calculating section 102, a weighting section 103, a distribution coefficient calculating section 104, and a noise distributing section 105.

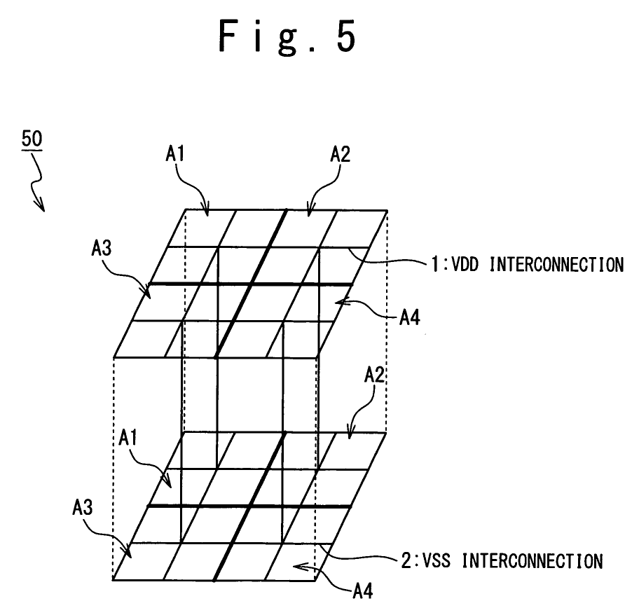

The region dividing section 101 generates a circuit division model 50 in which a layout pattern of the design target LSI is divided into a plurality of divisional regions by using the LSI layout data 31. The circuit division model 50 includes a power supply interconnection model. For example, the circuit division model 50 includes a power supply interconnection model 1 for a power supply voltage VDD and a power supply interconnection model 2 for a power supply voltage VSS, as shown in FIG. 5. The size and shape of the divisional region may be arbitrarily determined. For example, the region dividing section 101 generates the circuit division model 50 in which the LSI layout pattern is divided based on the shape of functional macros. Or, the region dividing section 101 generates the circuit division model 50 in which the layout pattern of the design target LSI is divided into the divisional regions having the same size and shape (for example, in a lattice shape). In an example shown in FIG. 5, the circuit division model 50 is divided into four regions A1 to A4.

The operation rate calculating section 102 calculates operation rates 40 of all the cells in the design target LSI by using the LSI connection data 32 and the timing data 33. The operation rate calculating section 102 calculates the operation rates 40 of the cells for each operation clock signal.

The weighting section 103 carries out weighting to the divisional regions according to the noise parameter affecting a current flowing in each of the divisional regions. Specifically, referring to the circuit division model 50, the weighting section 103 firstly specifies one of the divisional regions. Subsequently, referring to the cell library 34, the weighting section 103 calculates a summation of gate widths in the specified divisional region. At this time, a weighting coefficient depending on the operation rate 40 for each cell is assigned to the summation of gate widths. In this manner, the summation of gate widths in consideration of the operation rate 40 is calculated as the weighting coefficient Wn to the specified divisional region. For example, the weighting coefficient Wn set for the divisional region is calculated from the following equation (1) when Wi is a gate width in each cell and Ri is the operation rate 40 in each cell:

Wn=ΣWi×Ri (1)

As described above, the summation of gate widths weighted depending on the operation rate 40 (the weighting coefficient Wn) is calculated for all the divisional regions.

The noise parameter used for calculating the weighting coefficient Wn is not limited to the summation of gate widths but may be the number of transistors, a current value, or a combination of them. For example, referring to the cell library 34, the weighting section 103 calculates a total number of transistors in the specified divisional region. In this case, the weighting coefficient depending on the operation rate 40 for each cell is added to the total number of transistors. The weighting coefficient Wn depending on the total number of transistors in each divisional region is calculated in a manner similar to the equation (1). As described above, the weighting coefficient Wn in each divisional region may be set based on other noise parameters.

The distribution coefficient calculating section 104 calculates a distribution coefficient Kn for each divisional region by using a summation of gate widths in the divisional region (the weighting coefficient Wn), in which the summation is weighted based on the operation rate 40. Here, it is supposed that the number of divisional regions in the circuit division model 50 is N, the distribution coefficient Kn for each divisional region is calculated by the following equation (2):

$$K n = \frac{W n}{{\sum }_{n = 1}^{N} W n} \qquad ( 2 )$$

As described above, the distribution coefficient calculating section 104 calculates a rate of the summation of gate widths in the divisional region in consideration to the operation rate 40 (weighting coefficient Wn) to a summation of gate widths in the LSI as a distribution coefficient Kn related to the divisional region.

The noise distributing section 105 calculates a noise amount In distributed to each divisional region by using the distribution coefficient Kn. In addition, the noise distributing section 105 inserts a current source model corresponding to the noise amount In into each divisional region in the circuit division model 50. In this case, a current source is connected between the VDD power supply interconnection model 1 and the VSS power supply interconnection model 2. Moreover, the current source model inserted into each divisional region is generated to include impedances, capacitances, resistances, and inductances which can regulate a current of the current source model to have the noise amount In. The noise distributing section 105 calculates the noise amount In for each divisional region by using an entire noise amount 60 (I) of the design target LSI according to the following equation (3):

In=Kn×I (3)

As described above, the noise amounts In for all the divisional regions in the circuit division model 50 are calculated and are distributed to the respective divisional regions as current sources. Here, the entire noise amount 60 is a current (a noise amount) flowing through the whole of LSI when the design target LSI operates in response to an operation clock signal with a predetermined operation frequency. Specifically, it is preferable that the entire noise amount 60 is an actually measured value to all current values of the design target LSI. Or, the entire noise amount 60 may be a noise amount obtained through a highly accurate simulation. For example, a time series variation of a current flowing through each interconnection in the LSI is calculated through a SPICE simulation for the whole of LSI as a simulation method for calculating a highly accurate noise amount, and the entire noise amount 60 is calculated from the calculated current variation. Or, a radiation noise is simulated through an electromagnetic field simulation by using the current variation obtained through the SPICE simulation, to calculate the entire noise amount 60. As described above, the entire noise amount 60 used for the power supply noise model 70 can be obtained by the measured values or the highly accurate simulation.

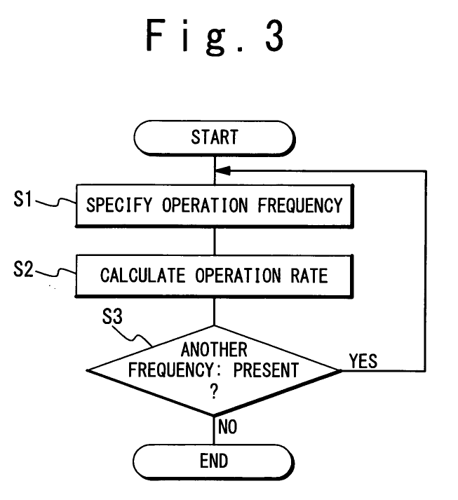

Next, referring to FIGS. 3 to 7, a power supply noise model generating method according to the present invention will be described.

FIG. 3 is a flowchart showing an operation of the operation rate calculating section 102 according to the embodiment of the present invention. The operation rate calculating section 102 firstly designates one of operation clock signals (of different operation frequencies) defined in the timing data 33 (step S1). The operation rate calculating section 102 subsequently calculates the operation rate 40 of each of the cell in the design target LSI based on the specified operation frequency (step S2). Specifically, referring to the operation frequency defined in the timing data 33 and the LSI connection data 32, the operation rate calculating section 102 specifies the cell operating in synchronization with the specified operation clock signal. Next, the operation rate calculating section 102 calculates, as the operation rate 40 of the cell, a proportion of logic gates operating in the cell during one period of the operating clock signal. The calculated operation rate 40 is related to the operation clock signal (of the operation frequency) and the cell, and stored in the storage unit 13. As described above, the operation rate calculating section 102 calculates the operation rate 40 of each cell operating in synchronization with the operation clock signal specified at step S2.

Here, when the timing data 33 includes other operation frequencies (of the operation clock signals) at which the operation rate 40 is not calculated yet, the operation rate calculating section 102 specifies another operation frequency (Yes at step S3 and step S1). In a same manner as described above, the operation rate calculating section 102 calculates the operation rate 40 of the cell operating in synchronization with the operation clock signal with a newly specified operation frequency (step S2). In the same manner, the process at the step S1 and the step S2 is repeated until the operation rate 40 is calculated which correspond to all of the operation clock signals (with the operation frequencies) included in the timing data 33. When the process at the step S2 is completed and the operation rates 40 are calculated which correspond to all the operation clock signals in the timing data 33, the process for calculating the operation rates 40 is completed (No at step S3).

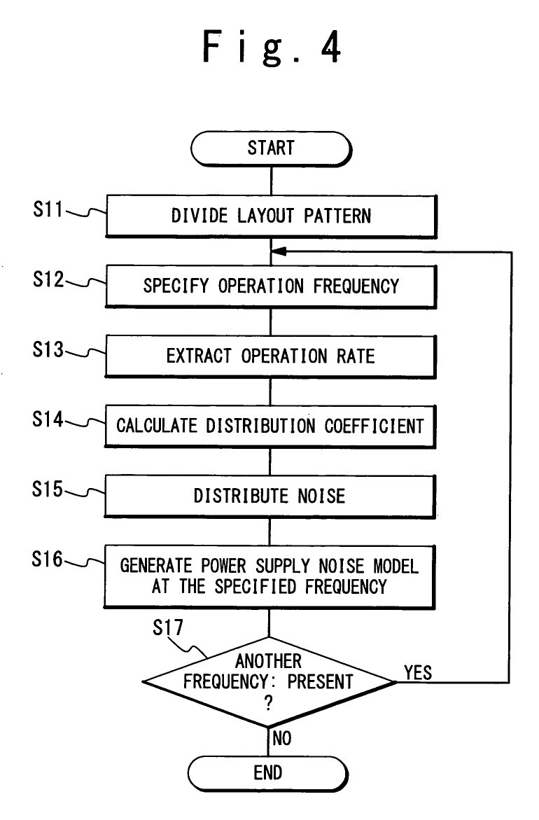

FIG. 4 is a flowchart showing an operation of a power supply noise model generating process according to the present invention. The region dividing section 101 divides the design target LSI into a plurality of divisional regions (step S11). For example, as shown in FIG. 5, the region dividing section 101 generates the circuit division model 50 in which the layout pattern data of the design target LSI is divided into four divisional regions A1 to A4.

The weighting section 103 specifies an operation frequency and extracts the operation rate 40 of a cell operating in the operation clock signal with a specified operation frequency (steps S12 and S13). The LSI generally operates in synchronization with the operation clock signal of a plurality of frequencies. Here, it is supposed that the design target LSI operates in synchronization with two operation frequencies fa and fb. In this case, the operation frequency fa is specified and the operation rate 40 of the cell is calculated and extracted which operates in synchronization with the operation clock signal with the operation frequency fa.

Next, the distribution coefficients given to the respective divisional regions A1 to A4 are calculated by using the circuit division model 50 and the extracted operation rates 40 (step S14). Specifically, the weighting section 103 firstly calculates a summation of gate widths for each of the divisional regions A1 to A4 and carries out the weighting based on the extracted operation rate 40 to the respective summation values. For example, when the divisional region A1 includes three cells operating in the operation clock signal with the operation frequency fa, when gate widths of the three cells are W1, W2, W3, respectively, and the operation rates 40 are R1, R2, and R3, respectively, a weighted summation WA1 of the gate widths in the divisional region A1 is W1×R1+W2×R2+W3×R3. In the same manner, weighted summations WA2 to WA4 of the gate widths corresponding to the divisional regions A2 to A4 are calculated.

The distribution coefficient calculating section 104 subsequently calculates distribution coefficients K1 to K4 respectively corresponding to the divisional regions A1 to A4 based on the weighted summation values WA1 to WA4 of the gate widths for the respective divisional regions. Specifically, the distribution coefficient calculating section 104 calculates, as the distribution coefficients K1 to K4, proportions of the summation values WA1 to WA4 of the gate widths for the respective divisional regions to a total summation of the gate widths in all the divisional regions of the design target LSI in consideration to the operation rates 40. For example, the distribution coefficient K1 to the divisional region A1 is calculated by WA1/(WA1+WA2+WA3+WA4). In the similar manner, the distribution coefficients K2 to K4 to the other divisional regions A2 to A4 are calculated and determined.

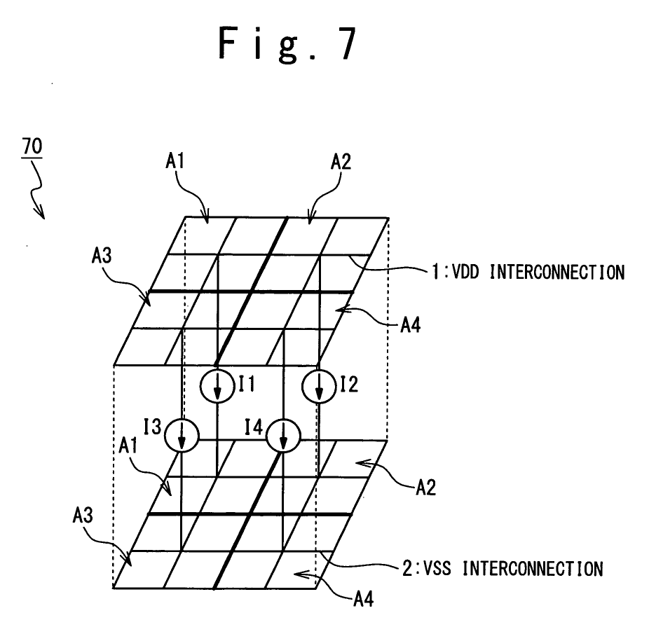

After the determination of the distribution coefficients K1 to K4, the noise distributing section 105 determines current amounts I1 to I4 respectively allocated to the divisional regions A1 to A4 by using the distribution coefficients K1 to K4 and the entire noise amount 60 I of the design target LSI in the operation clock signal with the operation frequency specified at step S12 (step s15). For example, the current amount I1 allocated to the divisional region A1 is calculated by K1×I. In the similar manner, the current amounts I2 to I4 allocated to the divisional regions A2 to A4 are calculated. The noise distributing section 105 generates a power supply noise model 70 in the operation clock signal with the operation frequency fa by inserting current source models corresponding to the calculated current amounts I1 to I4 into the divisional regions A1 to A4 in the circuit division model 50 (step S16). In this case, as shown in FIG. 7, the current source models corresponding to the current amounts I1 to I4 are inserted between the power supply interconnection model 1 and the power supply interconnection model 2.

The process described above generates the power supply noise model 70 in which the entire noise amount 60 (I) is distributed to the respective divisional regions based on the gate widths and the operation rate in each divisional region. The power supply noise model 70 generated at this time serves as a model when the design target LSI operates in the operation clock signal with the operation frequency fa specified at step S12.

When the timing data 33 includes another operation frequency which is not specified yet, the process flow advances to step S12 so as to generate the power supply noise model 70 corresponding to the newly specified operation frequency (Yes at step S17). In this case, since the operation frequency fb is not specified yet, the operation frequency fb is specified, and the power supply noise model 70 corresponding to the operation frequency fb is generated via a process from steps S12 to S16. Meanwhile, when generating the power supply noise models 70 corresponding to all the operation frequencies in the timing data 33, the power supply noise model generating apparatus 100 ends the power supply noise model generating process (No at step S17).

As described above, the power supply noise model generating apparatus 100 according to the present invention generates the power supply noise model 70 for each operation frequency in the design target LSI. The number of divisional regions is four in the embodiment, but, the number is not limited to four. In addition, as the number of divisional regions increases more, an accuracy of the obtained power supply noise model 70 can become higher.

The power supply noise model generating apparatus 100 generates a model of the design target LSI by distributing the entire noise amount 60 of the design target LSI to a plurality of divisional regions. In the present invention, a noise amount distributed to each divisional region is determined depending on a proportion of a noise amount in each divisional region to the entire noise amount of the design target LSI. According to this, a difference in a value of current flowing in each divisional region is reflected to the power supply noise model 70. Accordingly, a highly accurate simulation considering the noise amount in each divisional region can be realized by using the power supply noise model 70 according to the present invention for a noise design carried out after mounting an LSI on a substrate.

In addition, the entire noise amount 60 distributed to each divisional region of the power supply noise model 70 is obtained through an actual measurement or a highly accurate simulation. Thus, the power supply noise model 70 to which an absolute value of a noise amount actually generated in each divisional region is accurately reflected can be obtained.

In the present invention, since a noise amount considering the operation rate 40 and a noise parameter (for example, a gate width) in each divisional region is distributed to each divisional region, a power supply noise model to which the noise amount in each divisional region is accurately reflected can be generated. Furthermore, since the noise amount sometimes varies greatly for each functional macro, the power supply noise model 70 realizing a highly accurate noise design by setting a divisional region in units of functional macros can be generated.

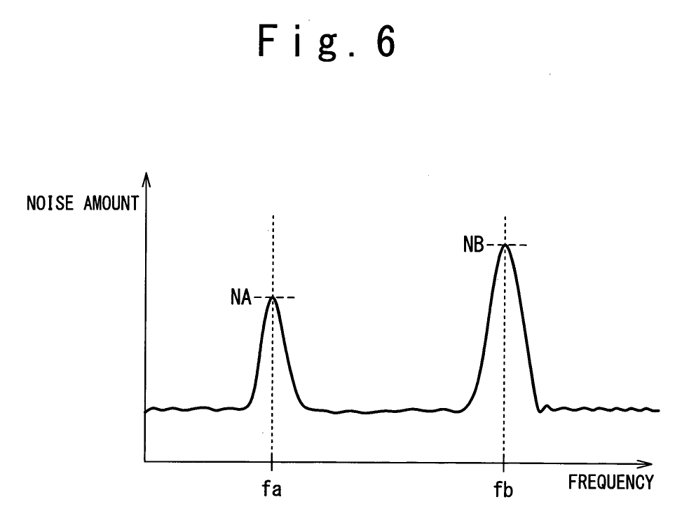

In addition, since being able to generate the power supply noise model 70 at each operation frequency, the power supply noise model generating apparatus 100 according to the present invention can carry out the noise design depending on the operation frequency. Referring to FIG. 6, a noise characteristic of the LSI represents peak values NA and NB of the noise amounts at the respective operation frequencies fa and fb. For this reason, it is beneficial to use the power supply noise model 70 at each operation frequency in the noise design.

As described above, the embodiments according to the present invention have been described in detail. However, a specific configuration is not limited to the above mentioned embodiments and modifications within the scope of the present invention are included in the present invention. In the embodiment, a current source corresponding to the noise amount In is inserted to each divisional region of the power supply noise model 70 as a noise source. However, the noise source is not limited to the current source if another circuit element corresponding to the noise source is employed. For example, a voltage source and a transistor and the like may be inserted instead of the current source. In this case, a voltage of the voltage source and a size of the transistor inserted to each divisional region are determined by using an entire voltage of a design target LSI measured or calculated by some method and the distribution coefficient Kn calculated by the above described method.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A power supply noise model generating method comprising:
dividing a layout pattern of a design target circuit layout into divisional regions;
calculating a distribution coefficient to each of the divisional regions based on a noise parameter in each divisional region;
distributing noise generated from a whole of the design target circuit to the divisional regions based on the distribution coefficients; and
generating a power supply noise model of the design target circuit by connecting a noise source corresponding to the distributed noise to a corresponding one of the divisional regions.

2. The power supply noise model generating method according to claim 1, further comprising:
performing weighting on each of the divisional regions by using a summation of gate widths in the divisional region,
wherein said calculating comprises:
calculating the distribution coefficient to the divisional region based on said weighting.

3. The power supply noise model generating method according to claim 2, further comprising:
calculating an operation rate of each of cells in a predetermined period of an operation clock signal,
wherein said performing comprises:
carrying out the weighting on each divisional region based on the operation rates.

4. The power supply noise model generating method according to claim 1, wherein said dividing comprises:
dividing the layout pattern of the design target circuit into the divisional regions for every functional macro in the design target circuit.

5. The power supply noise model generating method according to claim 1, wherein said calculating comprises:
calculating the distribution coefficient to each of the operation clock signals,
said distributing comprises:
acquiring noise generated from the whole of the design target circuit when the design target circuit operates in each operation clock signal; and
distributing the acquired noise to each of the divisional regions based on the distribution coefficients to the operation clock signals.

6. A power supply noise model generating apparatus comprising:
a storage section configured to store a data of a layout pattern of a design target circuit;
a dividing section configured to divide the design target circuit into divisional regions by using the layout pattern data;
a distribution coefficient calculating section configured to calculate a distribution coefficient to each of the divisional regions based on a noise parameter in each divisional region; and
a noise distributing section configured to distribute noise generated from the whole of the design target circuit to the divisional regions based on the distribution coefficients, and generate power supply noise models of the design target circuit by connecting noise sources corresponding to distributed portions of the noise with the divisional regions.

7. The power supply noise model generating apparatus according to claim 6, further comprising:
a weighting section configured to weight each of the divisional regions by using a summation of gate widths in each divisional region,
wherein said distribution coefficient calculating section calculates the distribution coefficient to each of the divisional regions based on the weighting coefficient.

8. The power supply noise model generating apparatus according to claim 7, further comprising:
an operation rate calculating section configured to calculate an operation rate of each of the divisional regions in a predetermined period of the operation clock signal,
wherein said weighting section weights each divisional region based on a corresponding one of the operation rates.

9. The power supply noise model generating apparatus according to claim 6, wherein said dividing section divides said design target circuit into the divisional regions in units of functional macros.

10. The power supply noise model generating apparatus according to claim 6, wherein said distribution coefficient calculating section calculates the distribution coefficient to each of the operation clock signals, and
said noise distributing section acquires noise generated from the whole of the design target circuit when the design target circuit operates in each operation clock signal, and distributes the acquired noise to each of the divisional regions based on the distribution coefficients to the operation clock signals.

11. A computer-readable recording medium in which a computer-readable program code is recorded to realize a power supply noise model generating method which comprises:
dividing a layout pattern of a design target circuit layout into divisional regions;
calculating a distribution coefficient to each of the divisional regions based on a noise parameter in each divisional region;
distributing noise generated from a whole of the design target circuit to the divisional regions based on the distribution coefficients; and
generating a power supply noise model of the design target circuit by connecting a noise source corresponding to the distributed noise to a corresponding one of the divisional regions.

12. The computer-readable recording medium according to claim 11, wherein said power supply noise model generating method further comprises:
performing weighting on each of the divisional regions by using a summation of gate widths in the divisional region,
wherein said calculating comprises:
calculating the distribution coefficient to the divisional region based on said weighting.

13. The computer-readable recording medium according to claim 12, wherein said power supply noise model generating method further comprises:
calculating an operation rate of each of cells in a predetermined period of an operation clock signal,
wherein said performing comprises:
carrying out the weighting on each divisional region based on the operation rates.

14. The computer-readable recording medium according to claim 11, wherein said dividing comprises:
dividing the layout pattern of the design target circuit into the divisional regions for every functional macro in the design target circuit.

15. The computer-readable recording medium according to claim 11, wherein said calculating comprises:
calculating said distribution coefficient to each of the operation clock signals,
said distributing comprises:
acquiring noise generated from the whole of the design target circuit when the design target circuit operates in each operation clock signal; and
distributing the acquired noise to each of the divisional regions based on the distribution coefficients to the operation clock signals.
